(19) United States
(12) Patent Application Publication
(10) Pub. No.: US 2009/0193503 A1
(43) Pub. Date: Jul. 30, 2009

(54) Network access control

(75) Inventors: Oleksiy Yu. Shevehenko, Ashburn, VA (US); Alexander V. Pyntikov, Ashburn, VA (US)

Correspondence Address: MCDERMOTT WILL & EMERY LLP, 600 13TH STREET, N.W., WASHINGTON, DC, 20005-3096, US

(73) Assignee: GBS LABORATORIES LLC

(21) Appl. No.: 12/010,582

(22) Filed: Jan. 28, 2008

(51) Int. Cl. G06F 21/00; G06F 15/173

(52) U.S. Cl. 726/4; 709/225

(57) ABSTRACT

A Network Access Control (NAC) device has at least first and second network interfaces with first and second network addresses, respectively, for providing connection to the network, and a computer device interface for providing connection to a user's computer device. A first network channel is configured in the NAC device over the first network interface for providing transactions between the computer device and the network using first application software installed in the NAC device. A second network channel is configured in the NAC device over the second network interface for providing transactions between the computer device and the network using second application software installed in the computer device.

### FIELD OF THE INVENTION

The present disclosure relates to computer systems, and more particularly, to devices and methods for controlling access to data networks.

### BACKGROUND ART

In the past several years, threats in the cyberspace have risen dramatically. With the ever-increasing popularity of the Internet, new challenges face corporate Information System Departments and individual users. Computing environments of corporate computer networks and individual computer devices are now opened to perpetrators using malicious software or malware to damage local data and systems, misuse the computer systems, or steal proprietary data or programs. The software industry responded with multiple products and technologies to address the challenges.

One way to compromise the security of a server is to cause the server to execute software such as Trojan horse that performs harmful actions on the server. For example, recently discovered Ransom-A Trojan horse displays messages threatening to delete files in the attacked database one-by-one every 30 minutes, until a ransom demand is fulfilled. The Trojan asks for payment and promises delivery of a special disarming code after the ransom is paid.

Another Trojan, dubbed Cryzip, encrypts victims' files and demands a payment to have them decrypted and unlocked. The Cryzip Trojan searches for files, such as source code or database files, on infected systems. It then uses a commercial zip library to store the encrypted files. The Trojan overwrites the victims' text and then deletes it, leaving only encrypted material that contains the original file name and encrypted data.

Attack or exploit codes are developed by hackers to take advantage of flaws in database software to steal or destroy data. For instance, the attack code may give the attacker higher privileges on the attacked database system.

There are various types of security measures that may be used to prevent a computer system from executing harmful software. System administrators may limit the software that a computer system can approach to only software from trusted developers or trusted sources. For example, the sandbox method places restrictions on a code from an unknown source. A trusted code is allowed to have full access to computer system's resources, while the code from an unknown source has only limited access. However, the trusted developer approach does not work when the network includes remote sources that are outside the control of the system administrator. Hence, all remote code is restricted to the same limited source of resources. In addition, software from an unknown source still has access to a local computer system or network and is able to perform harmful actions.

Another approach is to check all software executed by the computer device with a virus checker to detect computer viruses and worms. However, virus checkers search only for specific known types of threats and are not able to detect many methods of using software to tamper with computer's resources.

Further, firewalls may be utilized. A firewall is a program or hardware device that filters the information coming through the Internet connection into a private network or computer system. If an incoming packet of information is flagged by the filters, it is not allowed through. Firewalls use one or more of the following three methods to control traffic flowing in and out of the network.

A firewall may perform packet filtering to analyze incoming data against a set of filters. The firewall searches through each packet of information for an exact match of the text listed in the filter. Packets that make it through the filters are sent to the requesting system and all others are discarded.

Also, a firewall may carry out proxy service to run a server-based application acting on behalf of the client application. Accessing the Internet directly, the client application first submits a request to the proxy server which inspects the request for unsafe or unwanted traffic. Only after this inspection, the proxy server considers forwarding the request to a required destination.

Further, a firewall may perform stateful inspection, where it doesn't examine the contents of each packet but instead compares certain key parts of the packet to a database of trusted information. Information traveling from inside the firewall to the outside is monitored for specific defining characteristics, then incoming information is compared to these characteristics. The firewall looks not only at the IP packets but also inspect the data packet transport protocol header in an attempt to better understand the exact nature of the data exchange. If the comparison yields a reasonable match, the information is allowed through. Otherwise it is discarded.

However, the firewall technologies may miss vital information to correctly interpret the data packets because the underlying protocols are designed for effective data transfer and not for data monitoring and interception. For instance, monitoring based on an individual client application is not supported despite the fact that two identical data packets can have completely different meaning based on the underlying context. As a result, computer viruses or Trojan Horse applications can camouflage data transmission as legitimate traffic.

Further, a firewall is typically placed at the entry point of the protected network to regulate access to that network. However, it cannot protect against unauthorized access within the network by a network's user.

U.S. patent application Ser. No. 11/029,363 filed on Jan. 6, 2005 entitled “System and Method for Preventing Unauthorized Access to Computer Devices” that has the same inventor as the present application discloses a computer protection system coupled between a computer device and a data source/sink to protect the computer device from unauthorized access. The computer protection system employs a unidirectional path that transfers data supplied to the computer device in a form of an input to a display medium. Such input data can't carry computer viruses, worms, Trojan horses, spyware, etc. Moreover, even if a virus is already planted in a protected computer to request sending information from the computer to an external recipient, the protection system prevents the computer from sending the requested information.

However, in some network environments, such as a virtual private network (VPN) environment, a computer device must follow network access rules, e.g. VPN security policies, that govern access to various network resources. Therefore, it would be desirable to create computer protection device and method that would provide sufficient protection flexibility to enable a computer device to access network resources in accordance with required network policies without compromising computer's security.

### SUMMARY OF THE DISCLOSURE

The present disclosure offers novel circuitry and methodology for controlling user access to a network. In accordance with one aspect of the disclosure, a Network Access Control (NAC) device has at least first and second network interfaces with first and second network addresses, respectively, for providing connection to the network, and a computer device interface for providing connection to a user's computer device. For example, the first and second network addresses may be Internet Protocol (IP) addresses.

A first network channel is configured in the NAC device over the first network interface for providing transactions between the computer device and the network using first application software installed in the NAC device. A second network channel is configured in the NAC device over the second network interface for providing transactions between the computer device and the network using second application software installed in the computer device.

In accordance with an embodiment of the disclosure, the first network channel may be configured for providing a unidirectional path for supplying data from the network to the computer device only in a form of an input to a display medium.

Further, the first network channel may be configured for receiving data from the computer device only in a form of a data input signal entered from a data input device of the computer device.

The first network channel may be configured to prevent the computer device from accessing the network via the first network interface using the second application software.

In accordance with another aspect of the disclosure, the NAC device may have a first network channel configured over the first network interface for providing access of the computer device to a first network resource, and a second network channel configured over the second network interface for providing access of the computer device to a second network resource having a higher trust level than the first network resource.

The second network channel may be configured to prevent the computer device from accessing the first network resource via the second network interface.

In accordance with a further aspect of the disclosure, a NAC device may include a first network channel for providing transactions between the computer device and the network over a first network interface with a first network address. A second network channel may be configured in the NAC device for providing transactions between the computer device and the network over a second network interface having a second network address that does not coincide with the first network address, and over the computer device interface having a third network address that does not coincide with the first and second network addresses.

The NAC device may include a network address assignment server for providing to the computer device a forth network address that does not coincide with the third network address. The first to fourth network addresses may be IP addresses, and the network address assignment server may include a dynamic host configuration protocol (DHCP) server.

In accordance with another aspect of the disclosure, the NAC device may comprise a settings storage for storing authorization information defining access to the network, and an authorization control mechanism for comparing authorization data entered by the user with the stored authorization information to enable the user to access the network.

The authorization control mechanism may be configured for receiving at least one authorization signal from a data input device of the computer device to verify that the authorization data are entered by a live person using the computer device.

Further, the authorization control mechanism may be configured for providing the computer device with a request for the authorization data. The request may be supplied in a form of an input to a display medium.

In accordance with a method of the present disclosure, methodology for controlling access of a computer device to a network involves providing a first data transfer channel between the computer device and the network via a first network interface with a first network address to enable the computer device to access a first network resource, and providing a second data transfer channel between the computer device and the network via a second network interface with a second network address to enable the computer device to access a second network resource having a higher trust level than the first network resource.

The first data transfer channel may be configured for providing a unidirectional path for supplying data from the network to the computer device only in a form of an input to a display medium.

The second data transfer channel may be configured over a computer device interface having a third network interface address that does not coincide with the second network address.

The computer device may be provided with a fourth network address from a server having the third network address that does not coincide with the fourth network address.

Network management information may be transferred from the network over the second network interface.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the features are not necessarily drawn to scale but rather are drawn as to best illustrate the pertinent features, wherein:

FIG. 1 is a block diagram schematically illustrating an exemplary network environment where Network Access Control (NAC) devices and methodology of the present disclosure may be implemented.

FIG. 2 is a block diagram schematically illustrating an exemplary arrangement of a NAC device in accordance with the present disclosure.

FIG. 3 is a block diagram schematically illustrating an internal dynamic host configuration protocol (DHCP) procedure in accordance with the present disclosure.

### DETAILED DESCRIPTION OF THE EMBODIMENTS

The present disclosure is presented with an example of a virtual private network (VPN) environment. However, one skilled in the art would understand that the network access control (NAC) architecture and methodology disclosed herein may be implemented in any computer system or data network.

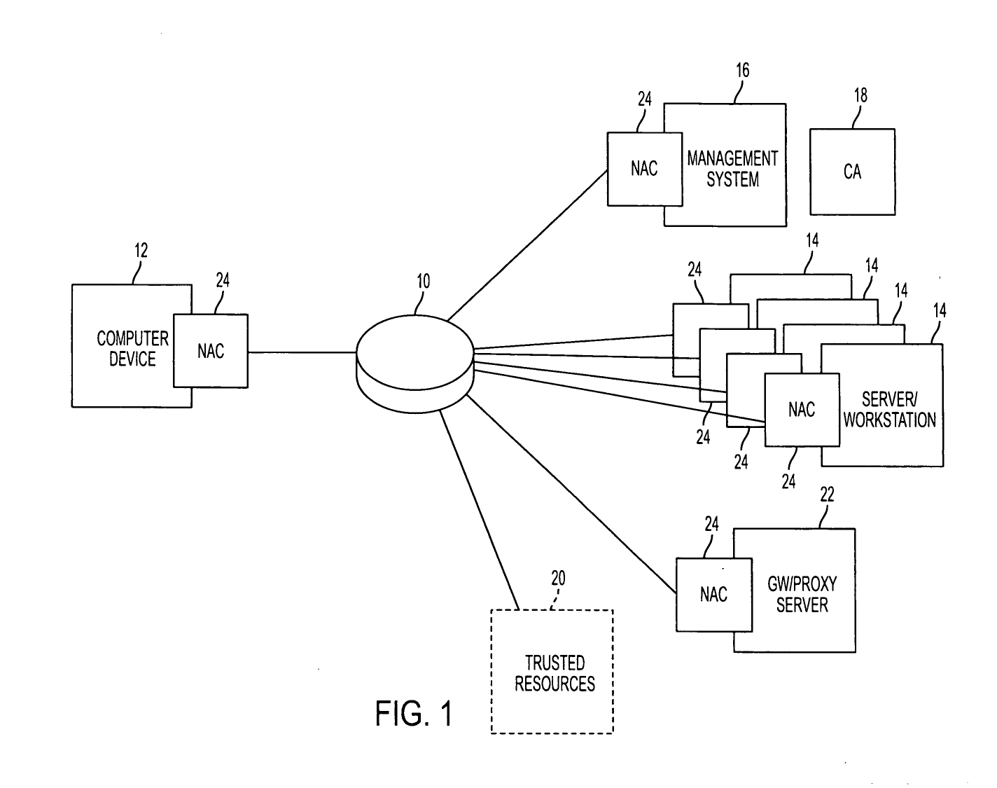

FIG. 1 shows an exemplary network environment where NAC devices and methodology of the present disclosure may be implemented. For example, a data network 10, such as a VPN, may provide wired or wireless connection of a computer device 12, such as a personal computer (PC), to multiple servers or workstations 14, and to a management system 16 that may be linked to a Certificate Authority (CA) 18. Further, the data network 10 may contain some Trusted Resources 20, and may have a gateway (GW)/Proxy server 22 that enables the computer device 10 to communicate with an external data network, such as an Internet.

A NAC device 24 may be provided for the computer device 12 and for any network device or system that communicates with the computer device 12. For example, FIG. 1 shows NAC devices 24 associated with the PC 12, servers/workstations 14, management system 16, and GW/Proxy server 22. The NAC device 24 is arranged so as ensure that the respective network device or system accesses the data network 10 only through the NAC device 24. For example, the NAC device 24 may be installed between the respective network device or system and the physical interface that connects that network device or system to the data network 10. The NAC device 24 may be provided externally or internally with respect to the associated network device or system. For example, the NAC device 24 may be arranged on one or more chips. The NAC devices 24 may have various hardware and/or software configurations that enable them to support specific network operations performed by the respective network devices or systems. Also, the hardware and/or software configuration of the NAC device 24 may be customized to correspond to a security policy established for the respective network device or system.

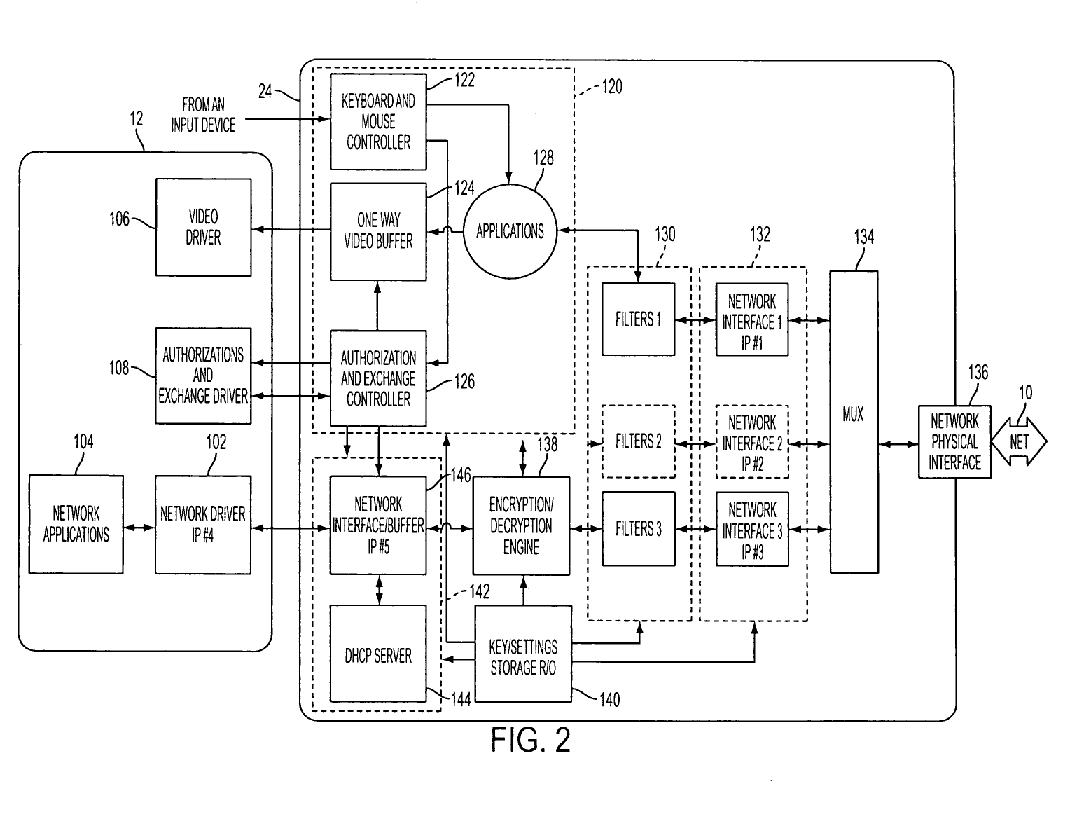

FIG. 2 shows an example of the NAC device 24 configured to control access of the computer device 12 to the data network 10. The computer device 12 may be any data processing device, such as a personal computer, workstation, personal digital assistant (PDA), telephone device, etc., coupled by a wired or wireless connection to the data network 10. For example, the computer device 12 may contain a network driver 102 that supports an Internet Protocol (IP) connection to the data network 10. The network driver 102 may be configured to receive an IP address (IP #4) from a Dynamic Host Configuration Protocol (DHCP) server external with respect to the computer device 12. As discussed in more detail later, the DHCP server may be provided on the NAC device 24. Further, the computer device 12 contains various network applications 104 that may include computer programs, such as Internet browsers, that control or support connection to the data network 10, or any other computer programs that may require access to the data network 10.

The computer device 12 may have a video driver 106 that receives data supplied to the computer device 12 in a form of an input to a display medium (such as video data), and controls output of these data using a display medium, such as a video monitor, internal or external with respect to the computer device 12. Also, the computer device 12 may be provided with an authorization and exchange driver 108. As disclosed in more detail below, the authorization and exchange driver 108 may support user's authorization and provide data exchange with the respective NAC device 24 in accordance with an established exchange protocol. In addition, the computer device 12 may have any other components and programs required to support its operations.

On a computer device side, the NAC device 24 may be connected to any high-speed bus of the computer device 12, such as a Universal Serial Bus (USB), Peripheral Component Interconnect (PCI) bus, PCI Express bus, etc., capable of supporting data exchange protocols between the NAC device 24 and the computer device 12 described below. The NAC device 24 may be arranged on one or more chips incorporated into the computer device 12. Alternatively, the NAC device 24 may be provides externally with respect to the computer device 12. For example, the NAC device 24 may be configured on a card attached to the computer device 12 via the respective port.

On a network side, the NAC device 24 may be coupled to a network connector that provides a physical interface to the data network 10. For example, the NAC device 24 may be coupled to a connector provided for connection of the computer device 12 to the data network 10. The NAC device 24 is connected between the computer device 12 and the data network 10 so as to provide data communication channels between the computer device 12 and the data network 10, and prevent direct data exchange between the computer device 12 and the data network 10.

As one skilled in the art of data processing will realize, the NAC device 24 may be implemented in a number of different ways. In particular, it may be implemented as a specifically engineered chip or a number of chips having data processing circuits and other components, such as a read-write memory and a read-only memory, for performing the functions described below. Alternatively, the NAC device 24 may be implemented using a general purpose digital signal processor, appropriate memories and programming.

The NAC device 24 may have an authorization and exchange section 120 that comprises a keyboard and mouse controller 122, a one-way video buffer 124, and an authorization and exchange controller 126. Also, the authorization and exchange section 120 contains applications 128 that may include any network-related computer programs, such as Internet browsers, e-mail and news programs, etc., required by the computer device 12 to operate with the data network 10. For example, the applications 128 may be computer programs that the computer device 12 is allowed to use in accordance with network security policies while accessing only untrusted network resources. The applications 128 may be run using a security sandbox arranged in a memory of the NAC device 24. As one skilled in the art of computer security, will realize, the security sandbox may be any security mechanism for safely running the applications 128.

The applications 128 may generate output data supplied via the one-way video buffer 124 to the video driver 106 that enables an internal or external display medium of the computer device 12 to produce graphical image corresponding to the output data. The applications 128 may generate the output data in a form of any signal, such as a video signal, that can be used as an input for a display medium such as a monitor. As described in more detail below, the output data may represent incoming data received from untrusted resources of the network 10. The keyboard and mouse controller 122 may be coupled to an input device, such as a keyboard and/or mouse, to enable a user to enter information required to run the network applications 128. As one skilled in the art would realize, the video signal displayable on a monitor can't carry computer viruses, worms, Trojan horses, spyware, etc. Moreover, even if a virus is already planted in the computer device 12 to request sending information from the computer device 12 to an external recipient, the one-way path created by the one-way video buffer 124 prevents the computer device 12 from sending the requested information. This computer protection mechanism is described in more detail in my copending U.S. patent application Ser. No. 11/029,363 filed on Jan. 6, 2005 entitled “System and Method for Preventing Unathorized Access to Computer Devices,” and incorporated herewith by reference.

The authorization and exchange controller 126 may control user's access to the network 10 based on network security policy information that may be loaded into the NAC device 24 during a setup mode discussed in more detail below. The network security policy information may include authorization information such as name or names of one or more users authorized to access the computer device 12, and password information corresponding to the users. Also, the authorization information may include other information identifying the authorized users, such as their fingerprint or biometric information. Further, the authorization information may contain user access control information indicating user's rights and privileges that may be defined in the network security policy. The user's rights and privileges may identify network resources, ports and/or particular IP addresses allowed or forbidden for a particular user, and/or network applications that are allowed or forbidden for that user.

In addition, the network security policy may define various levels of trust for different network resources—from the least trusted to the most trusted. The least trusted resources are resources that have the highest probability of compromising network security, such as certain web sites or web domains known for distributing malware. The most trusted resources have the lowest probability of compromising network security, such as certain intranet resources. The user access information loaded during the setup mode may indicate user's rights and privileges with respect to resources of particular trust levels. Further, as discussed in more details below, the authorization and exchange controller 126 may assign a particular network interface of the NAC device 24 for providing data exchange with a network resource of a particular trust level.

The authorization and exchange controller 126 interacts with the authorization and exchange driver 108 to determine whether a user of the computer device 108 is authorized to access the network 10, and if so, to determine her network access rights and privileges. To perform authorization, the authorization and exchange controller 126 may produce an authorization request signal, such as a video signal, that can be used as an input for a display medium such as a monitor. Over the one-way video buffer 124, the authorization request signal is supplied to the video driver 106 that controls a monitor of the computer device 12 to produce a graphical image corresponding to the authorization request. In response, the user enters required authorization information supplied via the authorization and exchange driver 108 to the authorization and exchange controller 126 for verification. The authorization and exchange driver 108 may be any device capable of reading authorization information entered by the user, such as password, fingerprint and/or biometric information. Based on the user's information, the authorization and exchange controller 126 performs user authorization procedure and determines network access rights and privileges for that user. As the user authorization procedure is performed in the NAC device 24 outside of the computer device 12, this procedure cannot be manipulated or falsified by a user or by malicious software planted on the computer device 12.

Further, the keyboard and mouse controller 122 determines whether user information, such as a user name and/or a password, is entered from an input device such as a keyboard or mouse, to make sure that the user information is entered by a live person, not produced by malicious software that emulates the user information. If so, the keyboard and mouse controller 122 produces a verification signal supplied to the authorization and exchange controller 126 to verify that user information is entered by a live person.

In response to the verification signal, the authorization and exchange controller 126 accepts the authorization information supplied from the authorization and exchange driver 108, and enables the user to access the network 10 within network access rights and privileges established for that user. Otherwise, the authorization and exchange controller 126 issues an error message indicating that the authorization is not valid and requesting the user to enter required information again.

In accordance with an exemplary embodiment of the disclosure, the NAC device 24 has multiple network channels for providing transactions between the computer device 12 and the network 10. Although FIG. 2 shows 3 network channels, one skilled in the art would realize that any number of channels exceeding one may be employed. Multiple network channels make it possible to provide user access to different network resources via different network channels. For example, network resources of a first trust level may be accessed via one network channel, whereas network resources of a second trust level lower that the first trust level may be accessed via another network channel. As discussed above, network resources may be assigned with various trust levels—from the lowest trust level to the highest trust level. Resources with the lowest trust level have the highest probability of compromising network security, such as certain web sites or web domains known for distributing malware. Resources with the highest trust level have the lowest probability of compromising network security, such as certain intranet resources.

The multi-channel arrangement of the NAC device 24 provides flexibility required to access various types of network resources using all available network applications, without compromising network security. The NAC device 24 has a filter section 130 and a network interface section 132 divided to provide multiple network channels. The filter section 130 has multiple filters corresponding to the respective network channels and the network interface section 132 has multiple network interfaces corresponding to the respective network channels. For example, FIG. 2 shows that the filter section 130 has filters 1, 2 and 3 corresponding to the first, second and third network channels, respectively. The network interface section 132 may include network interfaces 1, 2 and 3 corresponding to the first, second and third network channels, respectively. A multiplexer 134 connected between the network interfaces 1, 2, 3 and a network physical interface 136 of the NAC device 24 provides a data path between each of the network channels and the network 10. The network physical interface 136 may be a connection node that provides wired or wireless connection between the NAC device 24 and the network 10.

Filters 1, 2 and 3 may be any appropriate systems capable of filtering traffic via the respective network channel based on pre-determined criteria. For example, the filters may include a firewall for filtering IP traffic, antivirus software, etc. The network interfaces 1, 2 and 3 may be any IP network interface devices maintaining IP addresses for supporting IP connections over the network 10. Each network interface may have a unique IP address. For example, FIG. 2 shows that the network interface 1 has IP address IP #1, the network interface 2 has IP address IP #2, and the network interface 3 has IP address IP #3. The multiplexer 134 may by any device capable of providing IP data paths between an IP network and multiple devices with different IP addresses. For example, the multiplexer 134 may be a logical or physical IP switch.

Further, the NAC device 24 comprises an encryption/decryption engine 138 for encrypting data traffic transmitted to the network 10 over a selected network channel and for decrypting data traffic received from the network 10 over a selected network channel. For example, FIG. 2 shows that the encryption/decryption engine 138 provides encryption and/or decryption of traffic transferred over the second and third network channels (having IP addresses IP #2 and IP #3).

The NAC device 24 includes a key/settings read-only (R/O) storage 140 that contains the network security policy information pre-loaded in the setup mode. In particular, the key/settings storage 140 may contain encryption/decryption keys to support operations of the encryption/decryption engine 138. A particular user may be assigned with a particular set of keys to enable user's access to a specific network resource, such as a server or database, that may be assessed only using this set of keys. This would create additional protection that would prevent another user from accessing that network resource. Also, the storage 140 may include settings that define various aspects of the network security policy such as user authorization, user network access rights and privileges, etc.

Further, the NAC device 24 has an IP address control section 142 that includes an internal DHCP server 144 and a network interface buffer 146. As discussed in more detail later, the DHCP server 144 may provide a dynamic IP address (IP #4) for the network driver 102 of the computer device 12.

The network interface buffer 146 interacts with the network driver 102 to set the IP address of the network driver 102 and to enable the network driver 102 to establish an IP connection with the network 10 over a selected network channel of the NAC device 24. The network interface buffer 146 may have a unique IP address (IP #5) that enables IP connection of the network driver 102 to the network 10 only when the network driver 102 has the address IP #4 established by the internal DHCP server 144.

A fixed value for unique IP address IP #5 may be preloaded into the key/setting storage 140 during the set-up procedure. In addition, fixed values for unique IP addresses IP #1, IP #2 and IP #3 of the network interfaces 1, 2 and 3 also may be preloaded into the key/setting storage 140. During the operation, the network applications 104 operate with the network driver 102 having dynamic IP address IP #4 that may be produced only by the NAC device 24. Further, network interfaces with IP addresses IP #5 and IP #2, or network interfaces with IP addresses IP #5 and IP #3 are involved in providing IP connections between the computer device 12 and the network 10.

This mechanism prevents a user of the computer device 12 or malicious software from establishing a network connection, even when the user or malicious software manages to change the IP address IP #4 of the network driver 102 attempting to establish a network connection which is not allowed in accordance with rights and privileges of a particular user (having IP address IP #4).

For example, in accordance with a network security policy, a selected user (having a certain IP address) may have a right to access a privileged network resource such as a database with privileged information. A hacker may try to manipulate an IP address IP #4 of a computer device 12 connected to the network so as to imitate the IP address of the selected user and to obtain access to the privileged resource. However, the IP address IP #5 of the network interface/buffer 146 is configured to allow an IP connection between the computer device 12 and the NAC device 24 only when the computer device 12 has established IP address IP #4 and only if this address is received from the NAC device 24.

Moreover, the network interfaces 2 and 3 of the network interface section 132 have addresses IP #2 and IP #3 configured to allow an IP connection between the NAC device 24 and the network 10 only when the network interface/buffer 146 has established IP address IP #5. Accordingly, any change of the IP address IP #4 in the computer device 12 will cause immediate interruption of an IP connection between the computer device 12 and the network 10.

In addition, user network access rights and privileges defined for the IP address IP #4 may indicate specific network recourses or specific IP addresses that may be accessed from the IP address IP #4. As a result, even if malware planted into the computer device 12 makes an attempt to collect some privileged information and transfer it to an outside recipient, such transfer to a non-authorized IP address will be prevented.

The network interface 1 with IP address IP #1 may be assigned for providing IP connections only for operations run by the network applications 128 installed in the security sandbox inside the NAC device 24. These applications have access to the computer device 12 only using video signals produced by the one-way video buffer 124. The video signals displayed by a monitor of the computer device 12 cannot transfer viruses, malware, etc., and cannot be used for hacker attacks. Therefore, the network interface 1 may be utilized for accessing network resources having low levels of trust, such as Internet sites.

Hence, a multi-channel arrangement of the NAC device 24 supports a flexible network access control mechanism that may assign a particular network channel in the NAC device 24 to access network resources having a particular range of trust levels, where the network channel 1 with IP address IP #1 is assigned for providing access to the least trusted network resources. Moreover, the network access control mechanism of the present disclosure may assign a particular network channel in the NAC device 24 for supporting particular network applications. In particular, the network applications 128 installed in the NAC device 24 may access the network 10 only via the network channel 1 with IP address IP #1, whereas the network applications 104 installed in the computer device 12 may access the network 10 via the network channels 2 and 3.

Hence, only the secured network applications 128 may be allowed for accessing the least trusted network resources. From the other side, a user is enabled to run the network applications 104 installed in her computer device to communicate with more trusted network resources, such as intranet resources or trusted Internet resources. For example, the network channel 2 or 3 may enable a user to update the installed software from an Internet site of the respective software provider. The user network access rights and privileges determined by the authorization and exchange controller 126 based on settings preloaded into the key/setting storage 140 may define which applications are allowed for installation in the computer device 12 as applications 104, and which applications must be provided only by the NAC device 24 as applications 128. Also, the user network access rights and privileges may define which network channels in the NAC device 24 should be used to access specific network resources.

The NAC device 24 may operate as follows. After rebooting, the NAC device 24 is placed into a working mode, in which the key/settings storage 140 is locked to enable its operation in a read-only mode. Via the one-way video buffer 124, the authorization and exchange controller 126 supplies the computer device 12 with an authorization request message that may be displayed on a monitor of the computer device 12. In response, the user enters required authorization information using an input device coupled to the keyboard and mouse controller 122. Further authorization information may be provided using the authorization and exchange driver 108. The authorization and exchange controller 126 compares the received authorization information with the respective information stored in the key/settings storage 140, and monitors the keyboard and mouse controller 122 to determine whether at least some of this information was entered via an input device, i.e. by a live person, rather than by malicious software.

If the user access is authorized, the authorization and exchange controller 126 may enable network interfaces of the network interface section 132 allowed by the network access rights and privileges of a particular user defined by information loaded in the key/settings storage 140.

Further, IP address IP #2 or IP #3 of the enabled network interface 2 or 3 is assigned based on the network settings information stored in the key/settings storage 140. The encryption/decryption key information stored in the key/setting storage 140 may be used to enable operations of the encryption/decryption engine 138 to provide encryption and/or decryption of data being transferred over the enabled network channels in the NAC device 24. Also, based on the authorization information in the key/settings storage 140, the respective filters in the filter section 130 may be set up to provide prescribed filtering. In addition, as described above, a particular user may be assigned with a particular set of keys to enable user's access to a specific network resource, such as a server or database, that may be assessed only using this set of keys.

Thereafter, via the network interface 2 or 3, the NAC device 24 may establish a VPN connection with the management system 16 (FIG. 1). For example, the VPN connection may be established in accordance with a Secure Sockets Layer (SSL) protocol. Alternatively, Internet Protocol Security (IPsec) VPN connection may be established.

Using VPN encryption, the NAC device 24 may check whether the management system 16 (FIG. 1) has new network security policy information required to control the NAC device 24 or contains an update to the network security policy information already installed in the key/settings storage 140. The network security policy information may include authorization information, network access information, encrypt and decrypt keys, and any other information that may be desired to manage network access control. If a new or updated security policy information is available, the NAC device 24 downloads it from the management system 16 into a read-write memory, such as a flash memory (not shown), and begins a reboot procedure for switching into a setup mode.

In the setup mode, the key/settings storage 140 is unlocked to enable data writing, and the downloaded security policy information is loaded into this storage. It is noted that in the set-up mode, the NAC device 24 cannot be assessed from the computer device 12 or from the network 10 because all interfaces of the NAC device 24 are disabled. After loading the required information, the NAC device 24 may be rebooted for switching into the working mode, in which the key-settings storage 140 is locked to enable read-only access to this memory. As a result, neither in the setup mode nor in the working mode, a user or hacker can access the storage 140 in order to maliciously manipulate the security policy information.

If no new or updated network security policy information is available from the management system 16, the NAC device 24 begins installation of the remaining IP addresses for the enabled network interfaces of the network interface section 132, and the IP addresses IP #4 and IP #5. The IP addresses IP #1, IP #2, IP #3 and IP #5 may be static addresses installed based on fixed values preloaded into the key/settings storage 140.

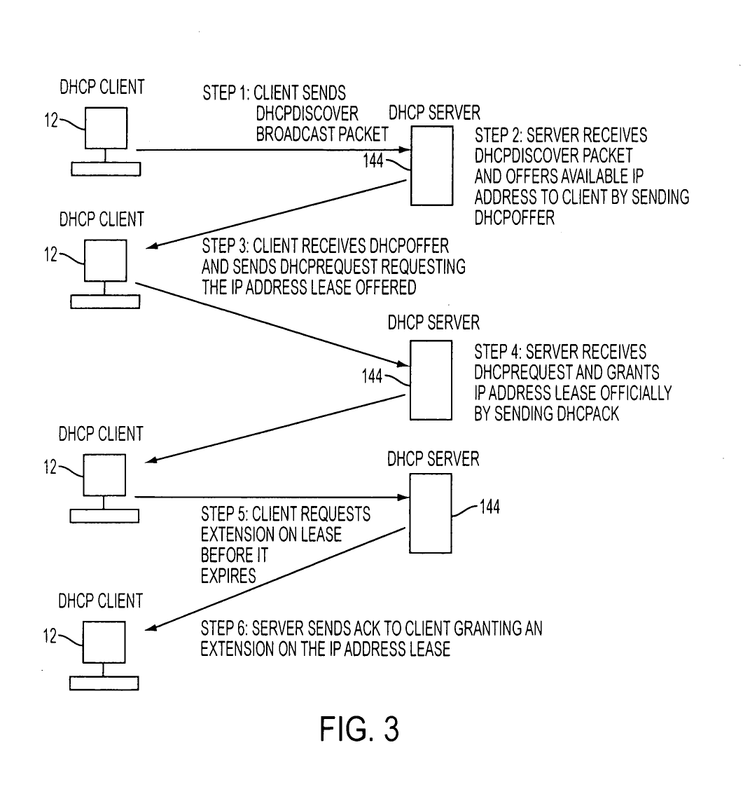

The IP address IP #4 assigned to the network driver 102 is a dynamic IP address produced by the DHCP server 144. FIG. 3 illustrates exemplary DHCP interactions performed between the DHCP server 144 and the computer device 12 that acts as a DHCP client. In particular, the computer device 12 may sent a DHCPDISCOVER broadcast package on the physical subnet to find available servers (step 1). For example, the broadcast package may be a User Datagram Protocol (UDP) packet with the broadcast destination of 255.255.255.255 or subnet broadcast address.

When the DHCP server 144 that has the IP address IP #5, for example, 10.1.1.1, receives the broadcast package, the DHCP server 144 extends an IP lease offer. This is done by requesting an IP address IP #4 for the computer device 12 from the key/settings storage 140. The IP address IP #4 may be defined by the management system 16 and pre-loaded into the key/settings storage 140 during the setup mode. For example, the requested IP address IP #4 may be 10.1.1.2. The DHCP server 144 sends the IP address IP #4 to the computer device 12 in a DHCPOFFER message. This message may contain the client's MAC address, followed by the IP address IP #4 offered to the client, the subnet mask, the lease duration and the IP address IP #5 of the DHCP server 144 (step 2).

When the computer device 12 receives the DHCPOFFER message, it must tell all the other DHCP servers that it has accepted an offer. To do this, the computer device 12 broadcasts a DHCPREQUEST message containing the IP address IP #5 of the DHCP server 142 (step 3).

The NAC device 24 prevents the DHCPOFFER message from being transferred to the network 10. Only the DHCP server 142 receives this message. In response, the DHCP server 142 initiates an acknowledgement phase of the configuration process by sending a DHCPACK packet to the computer device 12 (step 4). This packet includes the lease duration and any other configuration information that the computer device 12 might have requested.

Before the IP address lease expires, the computer device 12 may request an extension on lease by sending a request signal to the DHCP server 142 (step 5). In response, the DHCP server 142 may sends an acknowledgement signal ACK to grant extension on the IP address lease (step 6).

Hence, instead of an external DHCP server connected over the network 10, a protected DHCP server installed in the NAC device 24 is used for producing an IP address IP #4 of the computer device 12. Therefore, hackers or malicious software are prevented from performing any manipulations with the IP address of the computer device 12.

After the required IP addresses are installed, VPN configuration of the NAC device 24 may be carried out using VPN settings from the key/settings storage 140. Thereafter, allowed network applications 104 and 128 may be initiated to support any transactions performed between the computer device 12 and the network 10 over enabled network channels of the NAC device 24.

As discussed above, each network channel of the NAC device 24 may be assigned to allow user access to network resources having a certain range of trust levels. In particular, the network channel 1 with IP address IP #1 supports transactions with the least trusted network resources using the protected applications 128 installed in the NAC device 24. The network channels 2 and 3 with IP addresses IP #2 and IP #3 may be used to access more trusted network resources using the applications 104 installed in the computer device 12.

Hence, the NAC device 24 offers a user-friendly network access control mechanism that enables users of a computer network, such as a corporate network, to access any internal and external network resources within their network access rights and privileges without compromising network security.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art.

The embodiments described hereinabove are further intended to explain best modes known of practicing the invention and to enable others skilled in the art to utilize the invention in such or other embodiments and with the various modifications required by the particular applications or uses of the invention.

Accordingly, the description is not intended to limit the invention to the form disclosed herein. Also, it is intended that the appended claims be construed to include alternative embodiments.

What is claimed is:

1. A network access control (NAC) device for controlling access of a computer device to a network, and having at least first and second network interfaces for providing connection to the network, the NAC device comprising:
a first network channel configured over the first network interface having a first network address for providing transactions between the computer device and the network using first application software installed in the NAC device, and
a second network channel configured over the second network interface having a second network address for providing transactions between the computer device and the network using second application software installed in the computer device.

2. The device of claim 1, wherein the first and second network addresses are Internet Protocol (IP) addresses.

3. The device of claim 1, wherein the first network channel is configured for providing a unidirectional path for supplying data from the network to the computer device only in a form of an input to a display medium.

4. The device of claim 3, wherein the first network channel is further configured for receiving data from the computer device only in a form of a data input signal entered from a data input device of the computer device.

5. The device of claim 1, wherein the first network channel is further configured to prevent the computer device from accessing the network via the first network interface having the first network address using the second application software.

6. A NAC device for controlling access of a computer device to a network, and having at least first and second network interfaces for providing connection to the network, the NAC device comprising:
a first network channel configured over the first network interface having a first network address for providing access of the computer device to a first network resource, and
a second network channel configured over the second network interface having a second network address for providing access of the computer device to a second network resource having a higher trust level than the first network resource.

7. The NAC device of claim 6, wherein the first and second network addresses are IP addresses.

8. The device of claim 6, wherein the first network channel is further configured for providing a unidirectional path for supplying data from the network to the computer device only in a form of an input to a display medium.

9. The device of claim 6, wherein the second network channel is further configured to prevent the computer device from accessing the first network resource via the second network interface having the second network address.

10. A NAC device for controlling access of a computer device to a network, and having multiple network interfaces for providing connection to the network and at least one computer device interface for providing connection to the computer device, the NAC device comprising:
a first network channel for providing transactions between the computer device and the network over a first network interface with a first network address,
a second network channel for providing transactions between the computer device and the network over a second network interface having a second network address that does not coincide with the first network address, and over the computer device interface having a third network address that does not coincide with the first and second network addresses.

11. The device of claim 10 further comprising a network address assignment server for providing to the computer device a forth network address that does not coincide with the third network address.

12. The device of claim 11, wherein the first to fourth network addresses are IP addresses.

13. The device of claim 12, wherein the network address assignment server includes a dynamic host configuration protocol (DHCP) server.

14. The device of claim 11, wherein the first network channel is configured for providing a unidirectional path for supplying data from the network to the computer device only in a form of an input to a display medium.

15. A NAC device for controlling access of a user of a computer device to a network, comprising:
a settings storage for storing authorization information defining access to the network, and
an authorization control mechanism for comparing authorization data entered by the user with the stored authorization information to enable the user to access the network,
the authorization control mechanism being configured for receiving at least one authorization signal from a data input device of the computer device to verify that the authorization data are entered by a live person using the computer device.

16. The device of claim 15, wherein the authorization control mechanism is further configured for providing the computer device with a request for the authorization data, the request is being supplied in a form of an input to a display medium.

17. The device of claim 15 further comprising at least first and second network interfaces for providing connection to the network.

18. The device of claim 17 further comprising:
a first network channel configured over the first network interface having a first network address for providing transactions between the computer device and the network, and
a second network channel configured over the second network interface having a second network address for providing transactions between the computer device and the network

19. The device of claim 18, wherein the first network channel is configured for providing a unidirectional path for supplying data from the network to the computer device only in a form of an input to a display medium.

20. A method for controlling access of a computer device to a network, comprising the steps of:
providing a first data transfer channel between the computer device and the network via a first network interface with a first network address to enable the computer device to access a first network resource, and
providing a second data transfer channel between the computer device and the network via a second network interface with a second network address to enable the computer device to access a second network resource having a higher trust level than the first network resource.

21. The method of claim 20, wherein the first data transfer channel is configured for providing a unidirectional path for supplying data from the network to the computer device only in a form of an input to a display medium.

22. The method of claim 21, wherein the second data transfer channel is configured over a computer device interface having a third network interface address that does not coincide with the second network address.

23. The method of claim 22, further comprising the step of providing the computer device with a fourth network address from a server having the third network address that does not coincide with the fourth network address.

24. The method of claim 21, further comprising the step of transferring network management information from the network over the second network interface.
